(19) United States
(12) Patent Application Publication
(10) Pub. No.: US 2026/0174151 A1
(43) Pub. Date: Jun. 25, 2026

(54) ATOMIZATION DEVICE

(71) Applicant: SHENZHEN GEEKVAPE TECHNOLOGY CO., LTD., Shenzhen (CN)

(72) Inventor: Huaping LIAO, Shenzhen (CN)

(73) Assignee: SHENZHEN GEEKVAPE TECHNOLOGY CO., LTD., Shenzhen (CN)

(21) Appl. No.: 19/326,556

(22) Filed: Sep. 11, 2025

(30) Foreign Application Priority Data
Dec. 19, 2024 (CN) 202411890572.1
Dec. 19, 2024 (CN) 202423152542.9

(51) Int. Cl. A24F 40/485; A24F 40/10; A24F 40/42; A24F 40/44; A24F 40/46; A24F 40/50; H05B 3/22

(52) U.S. Cl. CPC A24F 40/485; A24F 40/10; A24F 40/42; A24F 40/44; A24F 40/46; A24F 40/50; H05B 3/22

(57) ABSTRACT

The present application provides an atomization device, the housing assembly is constructed to form the liquid storage chamber, the liquid guide hole, and the adjustment hole. The liquid guide hole is in communication with the liquid storage chamber, and the atomization assembly is disposed within the housing assembly, such that the liquid storage chamber and the liquid guide hole form a liquid path for supplying aerosol matrix to the atomization assembly. By providing the adjustment hole penetrating through the housing assembly, the adjustment member is limited within the adjustment hole and is configured to move linearly between a first position and a second position to drive the blocking member to move between the blocking position and the conducting position, so as to achieve blocking or conducting of the liquid guide hole.

### CROSS REFERENCE TO RELATED APPLICATION

The present application claims priority to Chinese Patent Application No. 202411890572.1, filed on Dec. 19, 2024, which claims priority to Chinese Patent Application No. 202423152542.9, filed on Dec. 19, 2024.

### TECHNICAL FIELD

The present application relates to the technical field of aerosol generating devices, and more particularly to an atomization device.

### BACKGROUND

The atomization devices are devices that heat liquid aerosol matrix to generate aerosols. Due to changes in the environment in which the atomization device is located, there is a risk of leakage of the liquid aerosol matrix contained in the liquid storage chamber of the atomization device. For example, when the temperature of the environment in which the atomization device is located is raised, the liquid aerosol matrix expands, causing increased pressure within the liquid storage chamber and resulting in aerosol matrix leakage. Another example is when the atomization device is left stationary for an extended period with the liquid guide hole facing downward, gravity can also cause aerosol matrix leakage. Furthermore, during long-distance transportation, the aerosol matrix can sway within the atomization device, causing the aerosol matrix to be heated and expanded, which leads to increased pressure within the liquid storage chamber and resulting in aerosol matrix leakage. Therefore, atomization devices with sealable liquid guide holes are emerged.

In the prior art, the atomization devices with sealable liquid guide holes often use a rotary adjustment member to drive a blocking member to block or conduct the liquid guide hole. However, in actual use, the rotary adjustment member often cannot intuitively distinguish whether the blocking member is currently in the blocked or conducted state, which effects the judgement and usage of users.

The above description is intended only to provide background information related to this application and does not necessarily constitute prior art.

### SUMMARY

One of the objectives of the embodiments of the present application is to provide an atomization device, which addresses the problem in prior art that the atomization device is unable to intuitively determine whether the liquid guide hole between the liquid storage chamber and the atomization assembly is currently blocked or conducted.

In order to address the above-mentioned technical problems, the embodiments of the present application adopt the following technical solutions:

In a first aspect, an embodiment of the present application provides an atomization device, which includes:
a housing assembly, constructed to form a liquid storage chamber, a liquid guide hole, and an adjustment hole; wherein the liquid storage chamber and the liquid guide hole are respectively located within the housing assembly, the liquid guide hole is in communication with the liquid storage chamber, and the adjustment hole penetrates through the housing assembly;
an atomization assembly, disposed within the housing assembly; and
an adjustment assembly, including a blocking member and an adjustment member; the blocking member is disposed within the housing assembly and provided with a blocking position and a conducting position, the adjustment member includes an adjustment portion and a drive portion connected to each other, the drive portion is connected to the blocking member, the adjustment portion is limited within the adjustment hole and configured to linearly move within the adjustment hole such that the adjustment member has a first position and a second position;
when the adjustment member is located at the first position, the blocking member is located at the blocking position and configured to block the liquid guide hole; when the adjustment member is located at the second position, the blocking member is located at the conducting position, and an aerosol matrix contained in the liquid storage chamber is able to flow through the liquid guide hole to the atomization assembly.

In some embodiments, the housing assembly is further constructed to form a buffer chamber, the buffer chamber is located within the housing assembly and is in communication with the liquid guide hole; at least a portion of the atomization assembly is located within the buffer chamber; and
when the adjustment member is located at the second position, the aerosol matrix contained in the liquid storage chamber is able to flow sequentially through the liquid guide hole and the buffer chamber toward the atomization assembly.

In some embodiments, the housing assembly includes a shell, a first bracket, and a first sealing member, the first bracket and the first sealing member are respectively disposed within the shell, the first sealing member is sealingly connected between the first bracket and the shell to define and form the liquid storage chamber, and the first sealing member defines and forms the liquid guide hole;
the adjustment assembly further includes a connecting member, the connecting member is connected between the blocking member and the adjustment member, and the blocking member is located on a central axis of the connecting member; and
when the adjustment member moves between the first position and the second position, the adjustment member drives the connecting member to rotate along the central axis, and rotation of the connecting member simultaneously drives the blocking member to move along the central axis between the blocking position and the conducting position

In some embodiments, the blocking member includes a blocking portion and a first connecting portion connected along the central axis, and the blocking portion is configured to block or conduct the liquid guide hole; and
the connecting member comprises a second connecting portion and a third connecting portion connected along the central axis, the second connecting portion is connected to the first connecting portion, and the third connecting portion is connected to the drive portion.

In some embodiments, the first connecting portion and the second connecting portion are spirally connected.

In some embodiments, one of the first connecting portion and the second connecting portion is provided with a spiral groove extending along the central axis, and another of the first connecting portion and the second connecting portion is provided with a guide post that matches the spiral groove, and the guide post is inserted into the spiral groove; and
when the connecting member rotates along the central axis, a position of the guide post within the spiral groove is changed to allow the blocking member to move between the blocking position and the conducting position.

In some embodiments, the first connecting portion is constructed to form a connecting hole having an opening toward the second connecting portion, a hole wall of the connecting hole is provided two guide posts disposed opposite to each other, the two guide posts are respectively extended radially along the central axis, and an outer wall of the second connecting portion is provided with two spiral grooves, each of two spiral grooves is arranged corresponding to each of the two guide posts; and
an outer wall of the first connecting portion is provided with at least one guide portion, the at least one guide portion is extended along the central axis and limited to the first bracket.

In some embodiments, the housing assembly further includes a second bracket disposed within the shell, the second bracket is located on a side of the first bracket away from the first sealing member, and a limiting hole is formed on a side of the second bracket adjacent to the connecting member; and
the connecting member further includes a fourth connecting portion and a limiting stop, the fourth connecting portion is connected between the second connecting portion and the third connecting portion along the central axis and extends through the limiting hole; the limiting stop is l ocated on an outer wall at a junction of the fourth connecting portion and the second connecting portion and abuts against a side of the limiting hole adjacent to the liquid guide hole.

In some embodiments, the third connecting portion is meshed with the drive portion.

In some embodiments, the third connecting portion is in a gear shape, and the drive portion is in a rack shape.

In some embodiments, the atomization assembly and the housing assembly are collectively constructed to form an airflow channel;
p the adjustment member further includes a connecting plate portion, the drive portion and the adjustment member are respectively connected to the connecting plate portion, and the connecting plate portion is provided with an air inlet hole;
when the adjustment member is located at the first position, the connecting plate portion blocks an air inlet end of the airflow channel, and the blocking member is located at the blocking position and configured to block the liquid guide hole; and
when the adjustment member is located at the second position, the air inlet hole is configured to communicate the adjustment hole with the air inlet end of the airflow channel, and the blocking member is located at the conducting position and configured to open the liquid guide hole.

In some embodiments, the liquid storage chamber contains a liquid storage cotton, and when the blocking member is located at the conducting position, the blocking member passes through the liquid guide hole and extends into the liquid storage chamber to press against the liquid storage cotton.

In some embodiments, the conducting position includes a first sub-conducting position and a second sub-conducting position, the second position comprises a first sub-position and a second sub-position, the air inlet hole comprises a first sub-air inlet hole and a second sub-air inlet hole, and a diameter of the second sub-air inlet hole is larger than that of the first sub-air inlet hole;
when the adjustment member is located at the first sub-position, the first sub-air inlet hole communicates the airflow channel with the adjustment hole, and the blocking member moves a first distance relative to the connecting member along the central axis and extends into the liquid storage chamber to be located at the first sub-conducting position;
when the adjustment member is located at the second sub-position, the second sub-air inlet hole communicates the airflow channel with the adjustment hole, and the blocking member moves a second distance relative to the connecting member along the central axis and extends into the liquid storage chamber to be positioned in the second sub-conducting position; and
the second distance is greater than the first distance.

In some embodiments, the housing assembly further includes a second bracket, a second sealing member, and a third sealing member; the second sealing member is sealingly connected between the first bracket and the second bracket, and the third sealing member is disposed between the second bracket and the connecting plate portion, and the third sealing member is constructed to form the air inlet end of the airflow channel; and
when the adjustment member is located at the first position, the connecting plate portion blocks the air inlet end.

In some embodiments, the housing assembly further includes a base disposed within the shell, the base and the shell are collectively constructed to form a mounting chamber; the adjustment member is disposed within the mounting chamber, and the base is connected to the first bracket to limit the second sealing member, the second bracket, and the third sealing member between the first bracket and the adjustment member;
a circuit board is disposed between the base and the second bracket, and a control switch is disposed on a side of the circuit board facing the adjustment member;
the adjustment member further comprises a trigger portion disposed on the connecting plate portion and sleeved onto the control switch;
when the adjustment member is located at the first position, the connecting plate portion blocks the air inlet end, the sealing member blocks the liquid guide hole, and the trigger unit turns off the control switch.
when the adjustment member is located at the first sub-position, the first sub-air inlet hole communicates the airflow channel with the adjustment hole, the blocking member moves a first distance relative to the connecting member along the central axis and extends into the liquid storage chamber to be located at the first sub-conducting position, and the trigger unit turns on the control switch; and
when the adjustment member is located at the second sub-position, the second sub-air inlet hole communicates the airflow channel with the adjustment hole, the blocking member moves a second distance relative to the connecting member along the central axis and extends into the liquid storage chamber to be located at the second sub-conducting position, and the trigger unit turns on the control switch.

In some embodiments, the housing assembly further includes a base disposed within the shell, the base and the shell are collectively constructed to form a mounting chamber, and the adjustment member is disposed within the mounting chamber; and
a mutually cooperating elastic engagement structure is provided between the adjustment member and the base, the elastic engagement structure is configured to limit the adjustment member to be located at one of the first position, the first sub-position, and the second sub-position.

In some embodiments, the adjustment member includes a first elastic engagement arm and a second elastic engagement arm, the first elastic engagement arm and the second elastic engagement arm are disposed on opposite sides of the connecting plate portion along a movement direction of the adjustment member, the first elastic engagement arm is provided with a first engagement portion, and the second elastic engagement arm is provided with a second engagement portion;
the base includes a first engagement groove, a second engagement groove, and a third engagement groove corresponding to the first engagement portion, respectively, and a fourth engagement groove, a fifth engagement groove, and a sixth engagement groove corresponding to the second engagement portion, respectively;
when the adjustment member is located at the first position, the first engagement portion is located in the first engagement groove, and the second engagement portion is located in the fourth engagement groove;
when the adjustment member is located at the first sub-position, the first engagement portion is located in the second engagement groove, and the second engagement portion is located in the fifth engagement groove; and
when the adjustment member is located at the second sub-position, the first engagement portion is located in the third engagement groove, and the second engagement portion is located in the sixth engagement groove.

In some embodiments, the shell includes a first shell and a second shell, the first shell and the second shell are connected to form an accommodating chamber, and a nozzle is formed on an end of the first shell away from the second shell; the first bracket is disposed within the accommodating chamber, the atomization assembly is inserted between the first bracket and the first shell, and is in communication with the nozzle; the first sealing member is sealingly connected between the first bracket, the atomization assembly, and the first shell; and the first sealing member, the first bracket, the atomization assembly, and the first shell are collectively constructed to form the liquid storage chamber.

In some embodiments, the atomization assembly includes an outer tube, an inner tube, a filling cotton, a liquid guide cotton, and a heating element; the outer tube is sealingly inserted between the first bracket and the nozzle, the inner tube is coaxially disposed within the outer tube, the filling cotton is filled between the outer tube and the inner tube, the liquid guide cotton and the heating element are respectively disposed within the inner tube, and the liquid guide cotton is interposed between the heating element and an inner wall of the inner tube; and
the outer tube is provided with a first liquid-passing hole, and the inner tube is provided with a second liquid-passing hole; the aerosol matrix contained in the buffer chamber is able to enter the liquid guide cotton through the first liquid-passing hole, the filling cotton, and the second liquid-passing hole in sequence, and the aerosol matrix is heated and atomized by the heating element on the liquid guide cotton to form an aerosol.

The beneficial effects of the atomization device provided by the embodiments of the present application are as follows:

In the atomization device provided by the embodiments of the present application, the housing assembly is constructed to form the liquid storage chamber, the liquid guide hole, and the adjustment hole. The liquid guide hole is in communication with the liquid storage chamber, and the atomization assembly is disposed within the housing assembly, such that the liquid storage chamber and the liquid guide hole form a liquid path for supplying aerosol matrix to the atomization assembly. By providing the adjustment hole penetrating through the housing assembly, the adjustment member is limited within the adjustment hole and is configured to move linearly between a first position and a second position to drive the blocking member to move between the blocking position and the conducting position, so as to achieve blocking or conducting of the liquid guide hole. Furthermore, the position of the adjustment member can be used to intuitively determine whether the liquid guide hole is blocked or conducted.

The above description is merely a summary of the technical solution of the present application. In order to provide a clearer understanding of the technical approach of the present application, implementation may be based on the contents of the specification. In order to further enhance the understanding of the above and other objects, features, and advantages of the present application, the following provides specific embodiments of the present application.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is an overall schematic view of the atomization device disclosed in the present application;

FIG. 2 is a cross-sectional view taken along a line A-A1 of FIG. 1, the adjustment member is located at the first sub-position, the blocking member is located at the first sub-conducting position, and the first sub-air inlet is in communication with the airflow channel and the adjustment hole;

FIG. 3 is a cross-sectional view taken along a line A-A1 of FIG. 1, the adjustment member is located at the first position, the blocking member is located at the blocking position, and the connecting plate portion blocks between the airflow channel and the adjustment hole;

FIG. 4 is a cross-sectional view taken along a line B-B1 of FIG. 1, the adjustment member is located at the first position, the blocking member is located at the blocking position, and the connecting plate portion blocks between the airflow channel and the adjustment hole;

FIG. 5 is a schematic view of an adjustment assembly in the atomization device disclosed in the present application;

FIG. 6 is a schematic view of an adjustment member in the atomization device disclosed in the present application;

FIG. 7 is a schematic view of a blocking member in the atomization device disclosed in the present application;

FIG. 8 is a schematic view of a connecting member in the atomization device disclosed in the present application;

FIG. 9 is a cross-sectional view of a first bracket in the atomization device disclosed in the present application taken along a line A-A1 of FIG. 1;

FIG. 10 is a cross-sectional view of a second bracket in the atomization device disclosed in the present application taken along a line A-A1 of FIG. 1;

FIG. 11 is a cross-sectional view taken along a line A-A1 of FIG. 1, the adjustment member is located at the first sub-position, the blocking member is located at the first sub-conducting position, and the first sub-air inlet hole communicates the airflow channel with the adjustment hole;

FIG. 12 is a cross-sectional view taken along a line B-B1 of FIG. 1, the adjustment member is located at the first sub-position, the blocking member is located at the first sub-conducting position, and the first sub-air inlet hole communicates the airflow channel with the adjustment hole;

FIG. 13 is a cross-sectional view taken along a line A-A1 of FIG. 1, the adjustment member is located at the second sub-position, the blocking member is located at the second sub-conducting position, and the second sub-air inlet hole communicates the airflow channel with the adjustment hole; and

FIG. 14 is a cross-sectional view taken along a line B-B1 of FIG. 1, the adjustment member is located at the second sub-position, the blocking member is located at the second sub-conducting position, and the second sub-air inlet hole communicates the airflow channel with the adjustment hole.

The reference numerals used in the figures are listed as following:
atomization device 100, shell 11, first shell 111, nozzle 1111, second shell 112, adjustment hole 1121, accommodating chamber 113, first bracket 12, guide hole 121, guide groove 122, first sealing member 13, liquid guide hole 131, liquid storage chamber 14, liquid storage cotton 141, second bracket 15, limiting hole 151, second sealing member 16, third sealing member 17, air inlet end 171, base 18, first engagement groove 181, second engagement groove 182, third engagement groove 183, fourth engagement groove 184, fifth engagement groove 185, sixth engagement groove 186, mounting chamber 19, outer tube 21, first liquid-passing hole 211, inner tube 22, second liquid-passing hole 221, filling cotton 23, liquid guide cotton 24, heating element 25, adjustment assembly 30, blocking member 31, blocking portion 311, first connecting portion 312, guide post 3121, connecting hole 3122, guide portion 3123, adjustment member 32, adjustment portion 321, drive portion 322, connecting plate portion 323, first sub-air inlet hole 3231, second sub-air inlet hole 3232, trigger portion 324, first elastic engagement arm 325, first engagement portion 3251, second elastic engagement arm 326, second engagement portion 3261, connecting member 33, central axis 331, second connecting portion 332, spiral groove 3321, third connecting portion 333, fourth connecting portion 334, limiting stop 335, circuit board 41, control switch 42, battery 43, charging port 44.

### DETAILED DESCRIPTION OF THE EMBODIMENTS

The following describes in detail embodiments of the present application. Examples of the embodiments are illustrated in the accompanying drawings, where identical or similar reference numerals throughout denote identical or similar elements or elements having identical or similar functions. The embodiments described below with reference to the accompanying drawings are illustrative and intended to explain the present application, and should not be construed as limiting the present application.

Unless otherwise specified, all embodiments and optional embodiments of the embodiments of the present application can be combined to form new technical solutions, unless otherwise conflicting.

Unless otherwise specified, all technical features and optional technical features of the embodiments of the present application can be combined to form new technical solutions.

In the description of the embodiments of the present application, it should be understood that terms such as “length,” “width,” “upper,” “lower,” “front,” “back,” “left,” “right,” “vertical,” “horizontal,” “top,” “bottom,” “inner,” and “outer” indicate positions or location relationships based on the positions or location relationships shown in the accompanying drawings. These terms are intended solely to facilitate the description of the present application and simplify the description, and are not intended to indicate or imply that the devices or components referred to must have, be constructed, or operate in a specific orientation. Therefore, they should not be construed as limiting the present application.

Furthermore, the terms “first” and “second” are used for descriptive purposes only and should not be construed as indicating or implying relative importance or implicitly specifying the number of technical features being referenced. Therefore, features designated “first” or “second” may explicitly or implicitly include one or more of such features.

In the description of the embodiments of the present application, “plurality” means two or more, and unless otherwise specifically defined, “two or more” includes two. Accordingly, “multiple groups” means two or more, including two.

In the description of the embodiments of the present application, unless otherwise expressly specified or limited, terms such as “mounted,” “connected,” “connecting,” and “fixed” should be interpreted broadly. For example, they may refer to fixed, removable, or integrated connections; mechanical or electrical connections; direct or indirect connections through an intermediate medium; and internal communication between two components or interaction between two components. Persons skilled in the art will understand the specific meanings of these terms in the present application based on the specific circumstances.

Although the present application has been described with reference to preferred embodiments, various modifications may be made and equivalent components may be substituted without departing from the scope of the present application. In particular, the various technical features described in the various embodiments may be combined in any manner, provided there are no structural conflicts. The present application is not limited to the specific embodiments disclosed herein but encompasses all technical solutions within the scope of the claims.

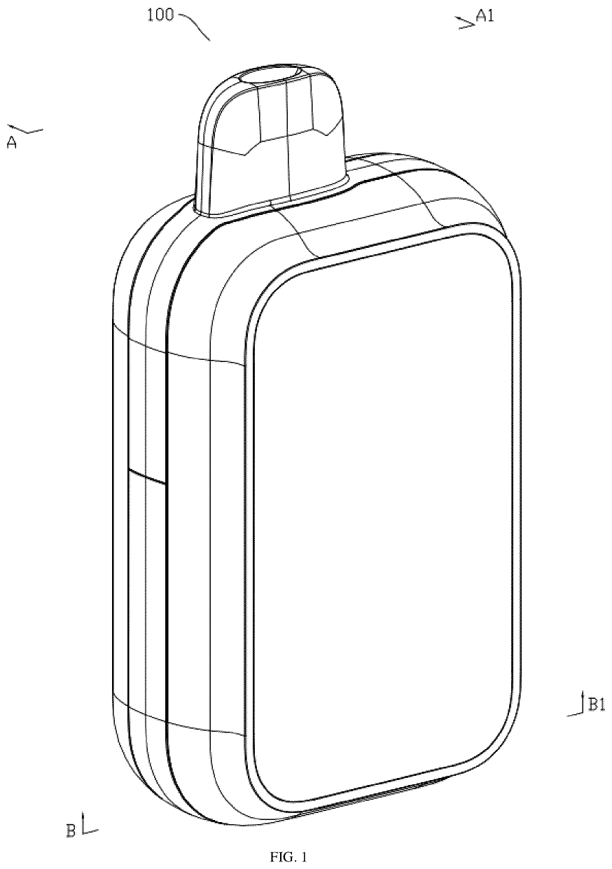

The following detailed description is provided with reference to the accompanying drawings and embodiments:
As shown in FIGS. 1-5, the present application provides an atomization device 100 including a housing assembly, an atomization assembly, and an adjustment assembly 30. The atomization assembly is located within the housing assembly, and the adjustment assembly 30 is located on the housing assembly. The adjustment assembly 30 is used to adjust aerosol matrix contained within the housing assembly to flow to the atomization assembly.

Furthermore, the housing assembly is constructed to form a liquid storage chamber 14, a liquid guide hole 131, and an adjustment hole 1121. The liquid storage chamber 14 and the liquid guide hole 131 are each located within the housing assembly, and the liquid guide hole 131 is in communication with the liquid storage chamber 14, so as to construct to form a liquid path for supplying the aerosol matrix to the atomization assembly.

The atomization assembly is located within the housing assembly. The atomization assembly is used to heat the aerosol matrix when powered, so as to atomize the heated aerosol matrix to generate an aerosol.

Furthermore, the adjustment assembly 30 includes a blocking member 31 and an adjustment member 32. The adjustment member 32 is used to adjust whether the blocking member 31 blocks or opens the liquid guide hole 131.

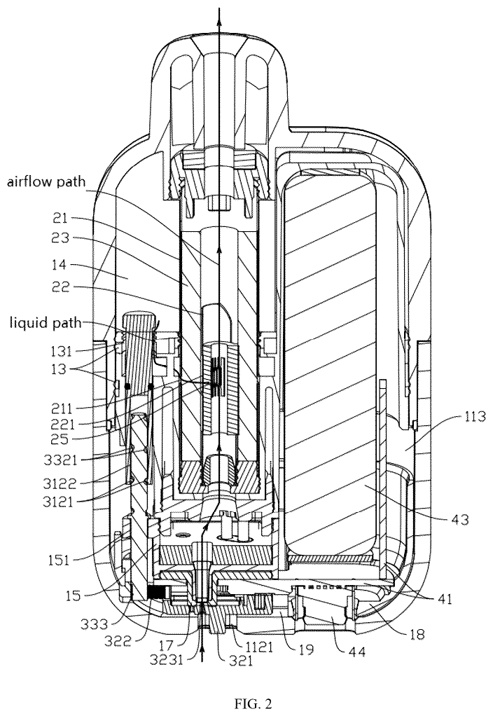

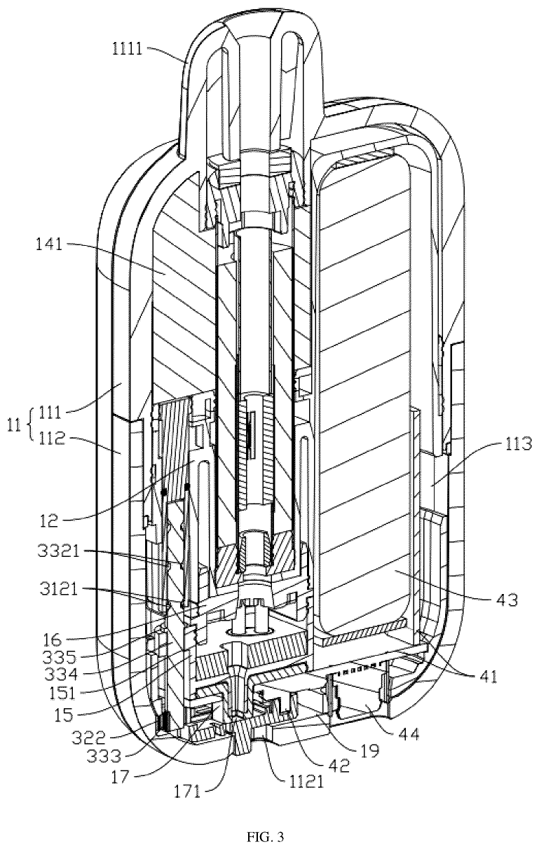

As shown in FIGS. 2-3, the blocking member 31 is disposed within the housing assembly and has a blocking position and a conducting position. An adjustment hole 1121 penetrates through the housing assembly. The adjustment member 32 includes an adjustment portion 321 and a drive portion 322 connected to each other, the drive portion 322 is connected to the blocking member 31. The adjustment portion 321 is disposed within the adjustment hole 1121, so as to allow the adjustment portion 321 to be exposed from the housing assembly. The adjustment portion 321 is configured to move linearly within the adjustment hole 1121, such that the adjustment member 32 has a first position and a second position.

Furthermore, when the adjustment member 32 is located at the first position, the blocking member 31 is located at the blocking position to block the liquid guide hole 131. In this position, the aerosol matrix contained in the liquid storage chamber 14 cannot flow through the liquid guide hole 131 to the atomization assembly, thereby preventing leakage of the aerosol matrix from the liquid guide cotton 24 in the atomization assembly due to the high pressure from the aerosol matrix.

When the adjustment member 32 is located at the second position and the blocking member 31 is located at the conducting position, the aerosol matrix contained in the liquid storage chamber 14 can flow through the liquid guide hole 131 to the atomization assembly.

In the atomization device provided in the embodiment of the present application, the housing assembly is constructed to form the liquid storage chamber 14, the liquid guide hole 131, and the adjustment hole 1211. The liquid guide hole 131 is in communication with the liquid storage chamber 14, and the atomization assembly is disposed within the housing assembly. This allows the liquid storage chamber 14 and the liquid guide hole 131 to form a liquid path for supplying the aerosol matrix to the atomization assembly. By controlling the adjustment portion 321 to be exposed within the adjustment hole 1121, the current position of the adjustment member 32 can be not only intuitively determined, the current position of the blocking member 31 can also be determined based on the current position of the adjustment member 32, thereby determining whether the liquid guide hole 131 is currently blocked or conducted. In other words, the position of the adjustment member 32 can be intuitively determined based on whether the liquid guide hole 131 is currently blocked or conducted.

In some embodiments, as shown in FIGS. 1 to 5, the housing assembly is further constructed to form a buffer chamber 132 located within the housing assembly and is in communication with a liquid guide hole 131. The liquid guide hole 131 communicates the liquid storage chamber 14 with the buffer chamber 132, so as to construct to form a liquid path for supplying aerosol matrix to the atomization assembly. At least a portion of the atomization assembly is located within the buffer chamber 132.

When the adjustment member 32 is located at the second position, the aerosol matrix contained in the liquid storage chamber 14 can flow sequentially through the liquid guide hole 131 and the buffer chamber 132 toward the atomization assembly.

The buffer chamber 132 can store a small amount of aerosol matrix, so as to keep the liquid guide cotton 24 in the atomization assembly in a moist state. This ensures that the aerosol matrix on the liquid guide cotton 24 is atomized into aerosol during a first suction after powering on the device, thereby preventing the dry-burning liquid guide cotton 24 from generating a burnt odor that affects the user experience.

In some embodiments, as shown in FIGS. 1 to 5, the housing assembly includes a shell 11, a first bracket 12, and a first sealing member 13. The first bracket 12 and the first sealing member 13 are respectively disposed within the shell 11. The first sealing member 13 is sealingly connected between the first bracket 12 and the shell 11 to define a liquid storage chamber 14. The first sealing member 13 defines a liquid guide hole 131.

Specifically, the first sealing member 13 is sealingly connected between the first bracket 12 and the shell 11 to define a liquid storage chamber 14 and a buffer chamber 132.

More specifically, as shown in FIG. 3, the shell 11 includes a first shell 111 and a second shell 112. The first shell 111 and the second shell 112 are connected to form an accommodating chamber 113. A nozzle 1111 is formed at one end of the first shell 111 away from the second shell 112.

As shown in FIG. 2, the first bracket 12 is positioned within the accommodating chamber 113. The atomization assembly is inserted between the first bracket 12 and the first shell 111 and communicates with the nozzle 1111. The first sealing member 13 is sealingly connected between the first bracket 12, the atomization assembly, and the first shell 111. The first sealing member 13, the first bracket 12, the atomization assembly, and the first shell 111 are collectively constructed to form the liquid storage chamber 14.

The atomization assembly further includes an outer tube 21, an inner tube 22, a filling cotton 23, a liquid guide cotton 24, and a heating element 25. The outer tube 21 is sealably inserted between the first bracket 12 and the nozzle 1111. The inner tube 22 is coaxially disposed within the outer tube 21, and the filling cotton 23 is filled the gap between the outer tube 21 and the inner tube 22. The liquid guide cotton 24 and the heating element 25 are each disposed within the inner tube 22, and the liquid guide cotton 24 is positioned between the heating element 25 and the inner wall of the inner tube 22.

The outer tube 21 defines a first liquid-passing hole 211, and the inner tube 22 is provided with a second liquid-passing hole 221. The aerosol matrix can sequentially enter the liquid guide cotton 24 through the first liquid-passing hole 211, the filling cotton 23, and the second liquid-passing hole 221. The liquid guide cotton 24 is heated by the heating element 25 and atomized to form an aerosol. Specifically, the aerosol matrix contained within the buffer chamber 132 can sequentially enter the liquid guide cotton 24 through the first liquid guide hole 211, the filling cotton 23, and the second liquid guide hole 221, and the aerosol matrix contained within the buffer chamber 132 is then heated by the heating element 25 on the liquid guide cotton 24 and atomized to form an aerosol.

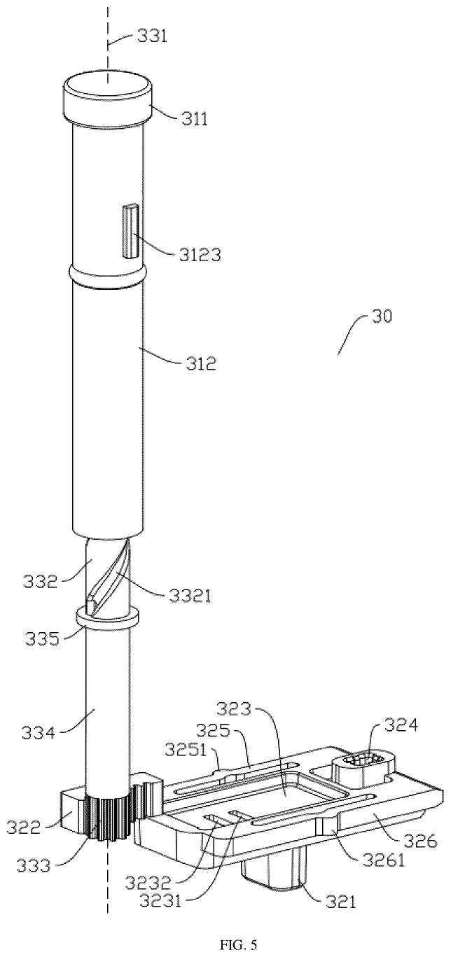

Furthermore, as shown in FIG. 5, the adjustment assembly 30 further includes a connecting member 33 connected between the blocking member 31 and the adjustment member 32. The adjustment member 32 drives the connecting member 33, such that the connecting member 33 drives the blocking member 31 to move between a blocking position and a conducting position.

Furthermore, the blocking member 31 is located on the central axis 331 of the connecting member 33. When the adjustment member 32 linearly moves between the first position and the second position, the adjustment member 32 drives the connecting member 33 to rotate along the central axis 331. This rotation of the connecting member 33 simultaneously drives the blocking member 31 to move along the length direction of the central axis 331 between the blocking position and the conducting position.

Furthermore, the adjustment member 32 can move linearly under the influence of an external force, so as to drive the connecting member 33 to rotate along the central axis 331. The rotation of the connecting member 33 drives the blocking member 31 to move linearly along the central axis 331, such that the blocking member 31 is caused to block or conduct the liquid guide hole 131.

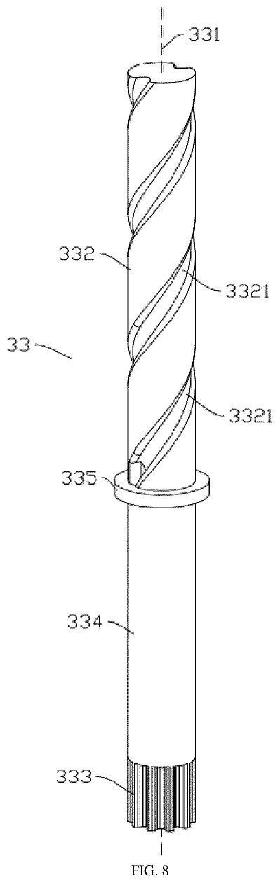

In some embodiments, as shown in FIGS. 5-8, the blocking member 31 includes a blocking portion 311 and a first connecting portion 312 connected along the central axis 331. The blocking portion 311 is used to block or conduct the liquid guide hole 131. The connecting member 33 includes a second connecting portion 332 and a third connecting portion 333 connected along the central axis 331. The second connecting portion 332 is connected to the first connecting portion 312, and the third connecting portion 333 is connected to the drive portion 322.

In some embodiments, the first connecting portion 312 and the second connecting portion 332 are screwed together. Under the action of an external force on the adjustment portion 321 and the limiting of the adjustment hole 1121, the adjustment member 32 can linearly move between a first position and a second position, such that the drive portion 322 drives the third connecting portion 333 to cause the connecting member 33 to rotate synchronously along the central axis 331. The second connecting portion 332 drives the first connecting portion 312 to cause the blocking member 31 to move synchronously along the central axis 331, such that the blocking portion 311 is caused to block or conduct the liquid guide hole 131.

In one embodiment, the first connecting portion 312 and the second connecting portion 332 are threadedly connected, so that rotation of the connecting member 33 along the central axis 331 simultaneously drives the blocking member 31 between the blocking position and the conducting position.

In another embodiment, as shown in FIGS. 5 and 7-8, one of the first connecting portion 312 and the second connecting portion 332 is provided with a spiral groove 3321 extending along the central axis 331. Another of the first connecting portion 312 and the second connecting portion 332 is provided with a guide post 3121 that matches the spiral groove 3321 and is inserted into the spiral groove 3321. Rotation of the connecting member 33 along the central axis 331 changes the position of the guide post 3121 within the spiral groove 3321, thereby causing the blocking member 31 to move along the central axis 331 between a blocking position and a conducting position.

Furthermore, in one embodiment, the first connecting portion 312 is constructed to form a connecting hole 3122 having an opening toward the second connecting portion 332, and the hole wall of the connecting hole 3122 is provided with two guide posts 3121 arranged opposite to each other, and the two guide posts 3121 extend respectively along the radial central axis 331, and the outer wall of the second connecting portion 332 is constructed to have one spiral groove 3321 corresponding to each guide post 3121.

In another embodiment, the first connecting portion 312 is constructed to form a connecting hole 3122 having an opening toward the second connecting portion 332. The hole wall of the connecting hole 3122 is provided with two symmetrical spiral grooves 3321 extending along the central axis 331. One guide post 3121 is formed on the outer wall of the second connecting portion 332 corresponding to each spiral groove 3321. The two guide posts 3121 extend radially outward into their respective spiral grooves 3321.

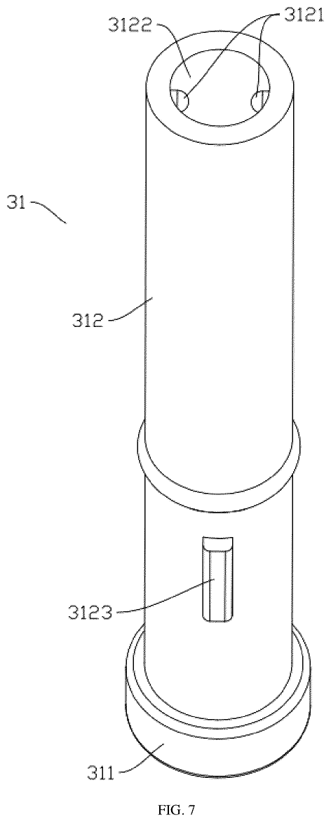

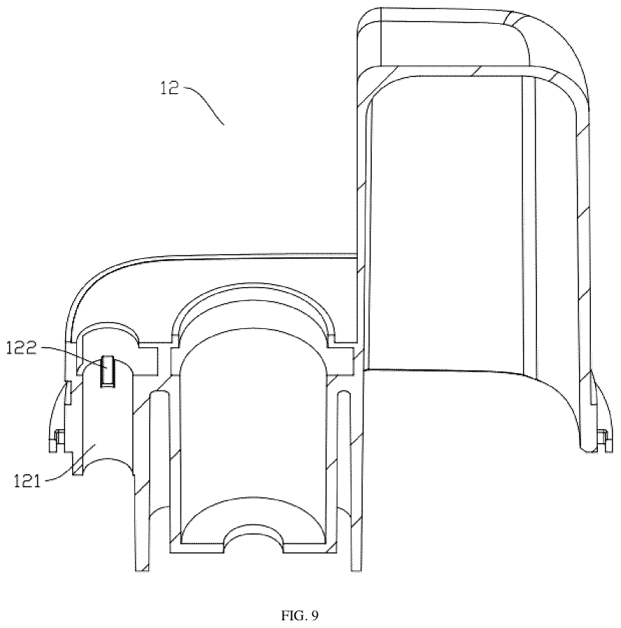

Furthermore, as shown in FIGS. 7 and 9, the first bracket 12 is constructed to form a guide hole 121. The first connecting portion 312 is disposed within the guide hole 121, such that the blocking member 31 moves along the central axis 331 while being limited by the guide hole 121.

Preferably, the outer wall of the first connecting portion 312 is provided with at least one guide portion 3123 extending along the central axis 331. The first bracket 12 is provided with a guide groove 122 adapted to mate with the guide portion 3123. The guide groove 122 at least partially communicates with the guide hole 121. The guide portion 3123 is limited within the guide groove 122. When the blocking member 31 moves along the central axis 331, at least one guide portion 3123 slides within the corresponding guide groove 122.

The mutual limiting between the guide groove 122 and the guide portion 3123 prevents circumferential rotation of the blocking member 31 during movement along the longitudinal direction of the central axis 331.

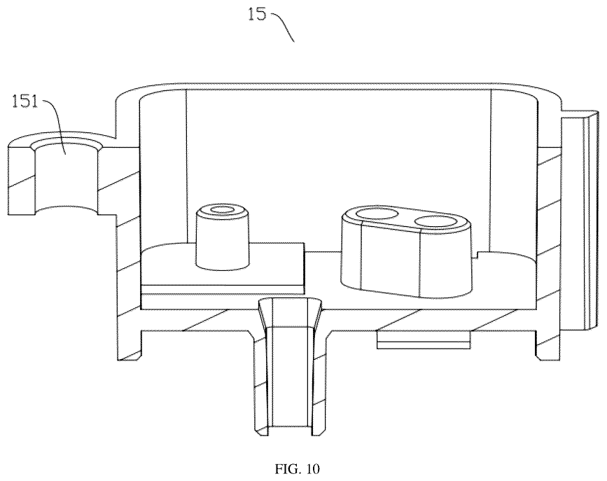

In some embodiments, as shown in FIGS. 2 and 10, the housing assembly further includes a second bracket 15. The second bracket 15 is disposed within the shell 11 and is located on the side of the first bracket 12 away from the first sealing member 13. A limiting hole 151 is formed on the side of the second bracket 15 adjacent to the connecting member 33.

As shown in FIGS. 2, 5, and 8, the connecting member 33 also includes a fourth connecting portion 334 and a limiting stop 335. The fourth connecting portion 334 is connected between the second connecting portion 332 and the third connecting portion 333 along the central axis 331 and extends through the limiting hole 151. The limiting stop 335 is located on the outer wall of the junction between the fourth connecting portion 334 and the second connecting portion 332 and abuts against the side of the limiting hole 151 adjacent to the liquid guide hole 131.

The limiting hole 151 limits the position of the connecting member 33, such that the connecting member 33 rotates more stably along the central axis 331. When the first connecting portion 312 and the second connecting portion 332 are in the spiral connection, the limiting hole 151 and the limiting stop 335 effectively limit the reaction force of the blocking member 31 on the connecting member 33 from affecting the connection between the third connecting portion 333 and the drive portion 322. This allows the connecting member 33 to stably drive the blocking member 31 along the central axis 331 under the drive of the adjustment member 32.

In some embodiments, the third connecting portion 333 and the drive portion 322 are meshed.

Furthermore, in one embodiment, the third connecting portion 333 is in a gear shape, and the drive portion 322 is in a rack shape.

In some embodiments, the atomization assembly and the housing assembly collectively form an airflow channel. Specifically, the inner tube 22, the nozzle 1111, the first bracket 12, and the second bracket 15 collectively form the airflow channel.

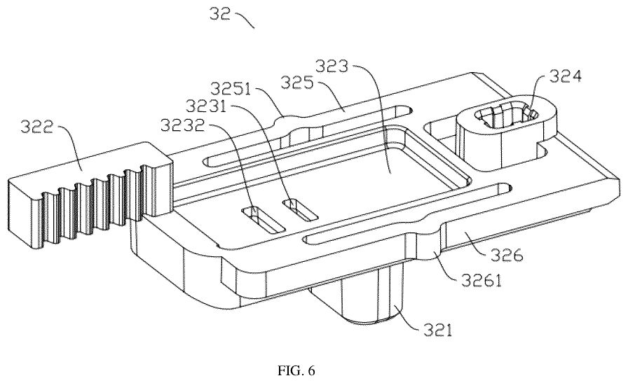

Furthermore, as shown in FIGS. 5-6, the adjustment member 32 also includes a connecting plate portion 323. The drive portion 322 and the adjustment portion 321 are respectively connected to the connecting plate portion 323, and the connecting plate portion 323 is provided with an air inlet hole for communicating with the airflow channel.

More specifically, as shown in FIG. 2, when the adjustment member 32 is located at the first position, the connecting plate portion 323 blocks the air inlet end 171 of the airflow channel to prevent the airflow from passing through. Simultaneously, the blocking member 31 is located at the blocking position and blocks the liquid guide hole 131 to prevent the aerosol matrix within the liquid storage chamber 14 from moving toward the atomization assembly. Thus, the adjustment member 32 simultaneously controls the blocking of the liquid guide hole 131 and the obstruction of the airflow channel.

As shown in FIG. 3, when the adjustment member 32 is located at the second position, the air inlet hole communicates the adjustment hole 1121 with the air inlet end 171 of the airflow channel to allow the airflow from passing through. Simultaneously, the blocking member 31 is located at the conducting position and opens the liquid guide hole 131. The adjustment member 32 thereby simultaneously controls the conducting of both the liquid guide hole 131 and the flow of the airflow channel.

Furthermore, in one embodiment, when the blocking member 31 is located at the blocking position, the blocking portion 311 is located within the liquid guide hole 131. When the blocking member 31 is located at the conducting position, the blocking portion 311 extends out of the liquid guide hole 131 away from the liquid storage chamber 14.

Preferably, as shown in FIG. 3, in another embodiment, a liquid storage cotton 141 is housed within the liquid storage chamber 14. When the blocking member 31 is located at the conducting position, the blocking portion 311 extends through the liquid guide hole 131 and into the liquid storage chamber 14 pressing against the liquid storage cotton 141. This allows the liquid guide cotton 24, under the pressure of the blocking portion 311, to release the stored aerosol matrix more quickly, allowing the released aerosol matrix to flow rapidly through the liquid guide hole 131 to the atomization assembly, thereby increasing the aerosol supply rate.

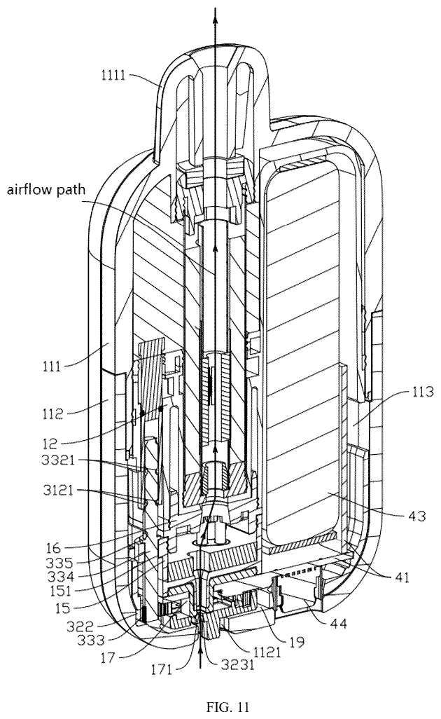

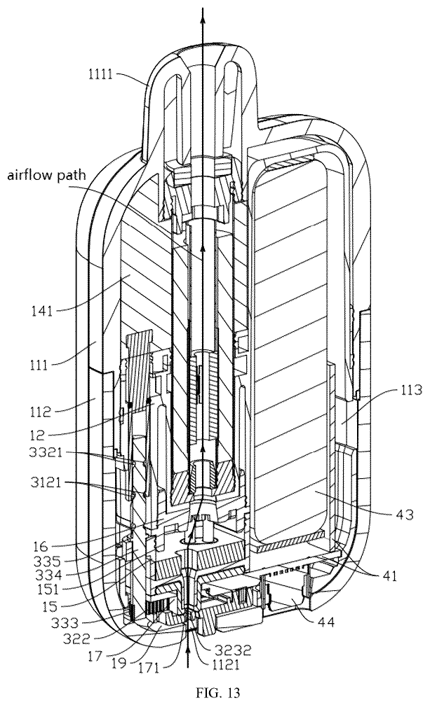

In some embodiments, as shown in FIGS. 11-14, the conducting position includes a first sub-conducting position and a second sub-conducting position. The second position includes a first sub-position and a second sub-position. The air inlet hole includes a first sub-air inlet hole 3231 and a second sub-air inlet hole 3232, and the second sub-air inlet hole 3232 has a larger diameter than that of the first sub-air inlet hole 3231.

When the adjustment member 32 is located at the first sub-position, the first sub-air inlet hole 3231 communicates the airflow channel with the adjustment hole 1121, and the blocking member 31 moves a first distance relative to the connecting member 33 along the central axis 331 and extends into the liquid storage chamber 14 to be located at the first sub-conducting position.

When the adjustment member 32 is located at the second sub-position, the second sub-air inlet hole 3232 communicates the airflow channel with the adjustment hole 1121, and the blocking member 31 moves a second distance relative to the connecting member 33 along the central axis 331 and extends into the liquid storage chamber 14 to be located at the second sub-conducting position.

Furthermore, the second distance is greater than the first distance. This ensures that when the blocking member 31 is located at the second sub-conducting position, the degree of compression applied to the liquid storage cotton 141 is greater than that of when the blocking member 31 is located at the first sub-conducting position. Therefore, when the blocking member 31 is located at the second sub-conducting position, the blocking member 31 can further compress the liquid storage cotton 141 to release the stored aerosol matrix, so as to increase the supply of the aerosol matrix.

Furthermore, since the diameter of the second sub-air inlet hole 3232 is larger than that of the first sub-air inlet hole 3231, when the adjustment member 32 is located at the second sub-position, the amount of airflow entering the airflow channel through the second sub-air inlet hole 3232 is greater than the amount of airflow entering the airflow channel through the first sub-air inlet hole 3231 when the adjustment member 32 is located at the first sub-position. This ensures that the supply of the aerosol matrix and the amount of airflow are directly proportional to each other in the different positions of the adjustment member 32.

In some embodiments, as shown in FIGS. 3-4 and 11-14, the housing assembly further includes a second sealing member 16 and a third sealing member 17. The second sealing member 16 is sealingly connected between the first bracket 12 and the second bracket 15, and the third sealing member 17 is disposed between the second bracket 15 and the connecting plate portion 323. The nozzle 1111, the inner tube 22, the first bracket 12, the second sealing member 16, the second bracket 15, and the third sealing member 17 collectively form the airflow channel, and the third sealing member 17 is constructed to form the air inlet end 171 of the airflow channel.

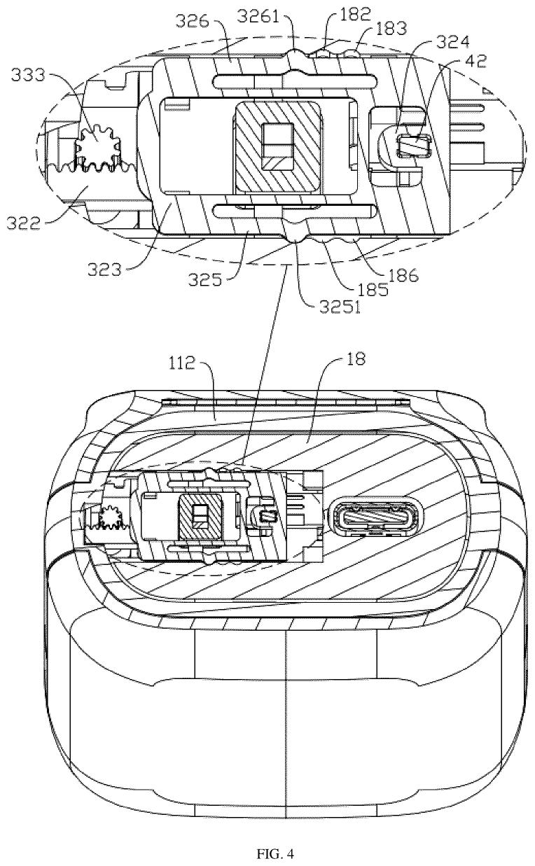

As shown in FIGS. 3-4, when the adjustment member 32 is located at the first position, the connecting plate portion 323 blocks the air inlet end 171, so as to block the airflow channel.

In some embodiments, the housing assembly further includes a base 18. The base 18 is disposed within the shell 11, and the base 18 together with the shell 11 forms a mounting chamber 19. The adjustment member 32 is disposed within the mounting chamber 19, and the base 18 and the first bracket 12 are connected in a snap-fit connection manner to limit the second sealing member 16, the second bracket 15, and the third sealing member 17 between the first bracket 12 and the adjustment member 32.

As shown in FIGS. 3-4, the atomization device 100 further includes an electronic control assembly; the electronic control assembly includes a circuit board 41 and a control switch 42. The circuit board 41 is limited and mounted between the base 18 and the second bracket 15. The control switch 42 is located on the side of the circuit board 41 facing the adjustment member 32 and is used to control power on and off of the atomization device 100.

Furthermore, as shown in FIGS. 5-6, the adjustment member 32 further includes a trigger portion 324. The trigger portion 324 is connected to the connecting plate portion 323 and is sleeved onto the control switch 42. The trigger portion 324 is used to trigger the control switch 42 to turn on or off the atomization device 100.

More specifically, as shown in FIG. 3, when the adjustment member 32 is located at the first position, the connecting plate portion 323 blocks the air inlet end 171, the sealing member blocks the liquid guide hole 131, and the trigger portion 324 turns off the control switch 42. Thus, only under the action of controlling the adjustment member 32, the atomization device 100 simultaneously turns off the circuit (i.e., shuts down), blocks the air channel, and blocks the liquid path. This effectively prevents the atomization device 100 from being accidentally triggered.

As shown in FIG. 11, when the adjustment member 32 is located at the first sub-position, the first sub-air inlet hole 3231 communicates the airflow channel with the adjustment hole 1121. The blocking member 31 moves a first distance relative to the connecting member 33 along the central axis 331 and extends into the liquid storage chamber 14 to be located at the first sub-conducting position, and the trigger portion 324 activates the control switch 42. Thus, only under the action of controlling the adjustment member 32, the atomization device 100 maintains the circuit turned on (i.e., power-on), and the air channel and the liquid path are conducted.

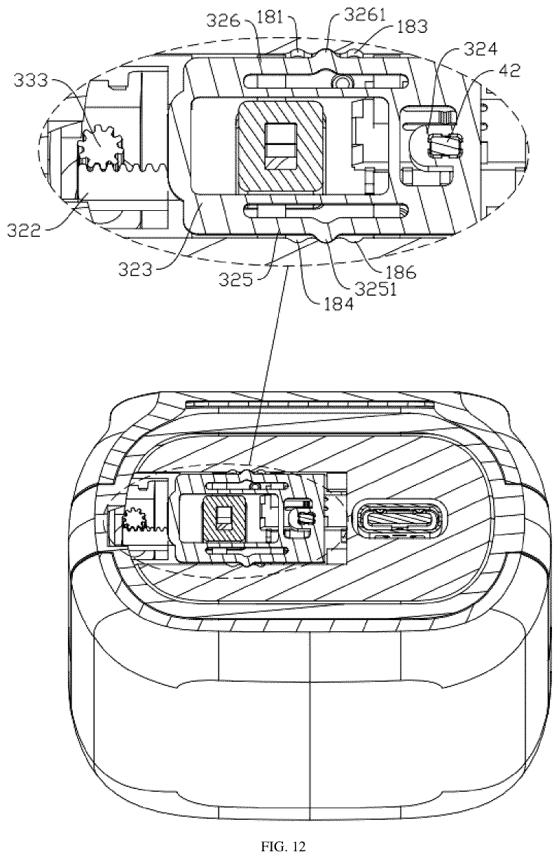

As shown in FIG. 12, when the adjustment member 32 is located at the second sub-position, the second sub-air inlet hole 3232 communicates the airflow channel with the adjustment hole 1121. The blocking member 31 moves a second distance relative to the connecting member 33 along the central axis 331 and extends into the liquid storage chamber 14 to be located at the second sub-conducting position, and the trigger portion 324 activates the control switch 42. Thus, only under the action of controlling the adjustment member 32, the atomization device 100 maintains the circuit turned on (i.e., power-on), and the air channel and the liquid path are conducted.

Preferably, the control switch 42 can also have switches including a low gear and a high gear. When the control switch 42 is in the low gear, the heating element 25 generates heat at a first power. When the control switch 42 is in the high gear, the heating element 25 generates heat at a second power. The second power is greater than the first power.

Furthermore, as shown in FIG. 11, when the adjustment member 32 is located at the first sub-position, the trigger portion 324 activates the control switch 42, such that the control switch 42 is in the low gear. In this case, the heating element 25 generates heat at the first power to atomize the aerosol matrix.

As shown in FIG. 12, when the adjustment member 32 is located at the second sub-position, the trigger portion 324 activates the control switch 42 such that the control switch 42 is in t he high gear. In this case, the heating element 25 generates heat at the first power to atomize the aerosol matrix.

Furthermore, as shown in FIG. 3, the electronic control assembly also includes a battery 43 and a charging port 44. The battery 43 is housed within the shell 11 and electrically connected to the circuit board 41 for supplying power to electrical components such as the circuit board 41, the control switch 42, and the heating element 25. The charging port 44 is electrically connected to the circuit board 41 and extends through the shell 11 for electrically connecting to a power source to charge the battery 43.

In some embodiments, as shown in FIGS. 4, 6, 12, and 14, a mutually cooperating elastic engagement structure is provided between the adjustment member 32 and the base 18. The elastic engagement structure is used to limit the adjustment member 32 to one of the first position, the first sub-position, and the second sub-position. The elastic engagement structure is arranged to further reduce the risk of accidental activation of the adjustment member 32 between the first position, the first sub-position, and the second sub-position.

Furthermore, in one embodiment, as shown in FIG. 6, the adjustment member 32 includes a first elastic engagement arm 325 and a second elastic engagement arm 326. The first elastic engagement arm 325 and the second elastic engagement arm 326 are arranged on opposite sides of the connecting plate portion 323 along the movement direction of the adjustment member 32. The first elastic engagement arm 325 is provided with a first engagement portion 3251, and the second elastic engagement arm 326 is provided with a second engagement portion 3261.

As shown in FIGS. 4, 12, and 14, the base 18 includes a first engagement groove 181, a second engagement groove 182, and a third engagement groove 183, respectively corresponding to the first engagement portion 3251; and a fourth engagement groove 184, a fifth engagement groove 185, and a sixth engagement groove 186, respectively corresponding to the second engagement portion 3261.

As shown in FIG. 4, when the first engagement portion 3251 and the first engagement groove 181 are mutually limited; the second engagement portion 3261 and the fourth engagement groove 184 are mutually limited, and the adjustment member 32 is located at the first position.

As shown in FIG. 12, when the first engagement portion 3251 and the second engagement groove 182 are mutually limited, the second engagement portion 3261 and the fifth engagement groove 185 are mutually limited, and the adjustment member 32 is located at the first sub-position.

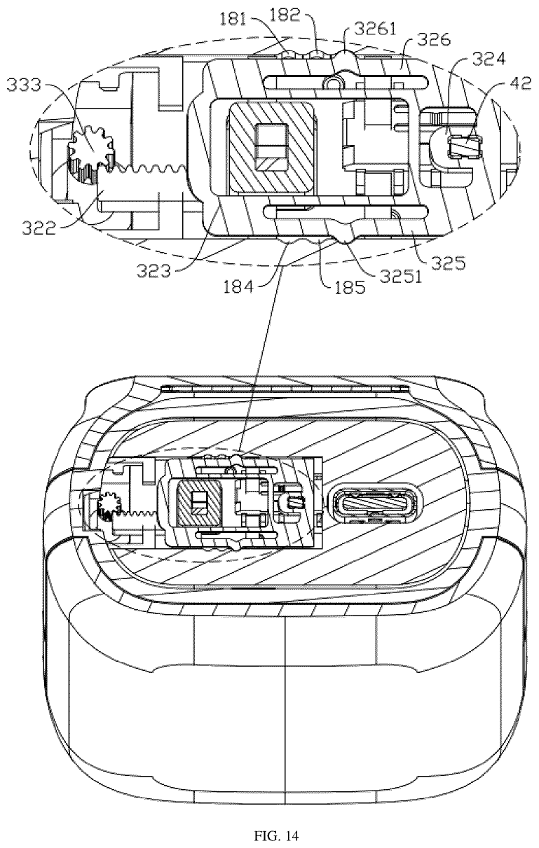

As shown in FIG. 14, when the first engagement portion 3251 and the third engagement groove 183 are mutually limited, the second engagement portion 3261 and the sixth engagement groove 186 are mutually limited, and the adjustment member 32 is located at the second sub-position.

Preferably, the first engagement portion 3251 and the second engagement portion 3261 are disposed opposite each other in a horizontal plane, and a connecting line between the first engagement portion 3251 and the second engagement portion 3261 is perpendicular to the movement direction of the adjustment member 32 in the horizontal plane.

Further, as shown in FIG. 2, in one embodiment, the adjustment hole 1121 and the nozzle 1111 are located on opposite sides of the shell 11. In other words, the adjustment hole 1121 is formed in the second shell 112 and is located on the side of the second shell 112 away from the first shell 111. Therefore, when the atomization device 100 is held with the nozzle 1111 facing upward, the adjustment hole 1121 is located at the bottom of the atomization device 100, so as to further reduce the risk of accidental activation of the adjustment portion 321.

Preferably, the adjustment portion 321 does not extend beyond the adjustment hole 1121, so as to further reduce the risk of accidental activation of the adjustment portion 321.

For some embodiments, refer to the figures in conjunction with the other figures.

The above description is merely a preferred embodiment of the present application and is not intended to limit the present application. Any modifications, equivalent substitutions, and improvements made within the spirit and principles of the present application are intended to be included within the scope of protection of the present application.

What is claimed is:

1. An atomization device, comprising:
a housing assembly, constructed to form a liquid storage chamber, a liquid guide hole, and an adjustment hole; wherein the liquid storage chamber and the liquid guide hole are respectively located within the housing assembly, the liquid guide hole is in communication with the liquid storage chamber, and the adjustment hole penetrates through the housing assembly;
an atomization assembly, disposed within the housing assembly; and
an adjustment assembly, comprising a blocking member and an adjustment member; wherein the blocking member is disposed within the housing assembly and provided with a blocking position and a conducting position, the adjustment member comprises an adjustment portion and a drive portion connected to each other, the drive portion is connected to the blocking member, the adjustment portion is limited within the adjustment hole and configured to linearly move within the adjustment hole such that the adjustment member has a first position and a second position;
wherein when the adjustment member is located at the first position, the blocking member is located at the blocking position and configured to block the liquid guide hole; when the adjustment member is located at the second position, the blocking member is located at the conducting position, and an aerosol matrix contained in the liquid storage chamber is able to flow through the liquid guide hole to the atomization assembly.

2. The atomization device according to claim 1, wherein the housing assembly is further constructed to form a buffer chamber, the buffer chamber is located within the housing assembly and is in communication with the liquid guide hole; at least a portion of the atomization assembly is located within the buffer chamber; and
when the adjustment member is located at the second position, the aerosol matrix contained in the liquid storage chamber is able to flow sequentially through the liquid guide hole and the buffer chamber toward the atomization assembly.

3. The atomization device according to claim 1, wherein the housing assembly comprises a shell, a first bracket, and a first sealing member, the first bracket and the first sealing member are respectively disposed within the shell, the first sealing member is sealingly connected between the first bracket and the shell to define and form the liquid storage chamber, and the first sealing member defines and forms the liquid guide hole;
the adjustment assembly further comprises a connecting member, the connecting member is connected between the blocking member and the adjustment member, and the blocking member is located on a central axis of the connecting member; and
wherein when the adjustment member moves between the first position and the second position, the adjustment member drives the connecting member to rotate along the central axis, and rotation of the connecting member simultaneously drives the blocking member to move along the central axis between the blocking position and the conducting position.

4. The atomization device according to claim 3, wherein the blocking member comprises a blocking portion and a first connecting portion connected along the central axis, and the blocking portion is configured to block or conduct the liquid guide hole; and
the connecting member comprises a second connecting portion and a third connecting portion connected along the central axis, the second connecting portion is connected to the first connecting portion, and the third connecting portion is connected to the drive portion.

5. The atomization device according to claim 4, wherein the first connecting portion and the second connecting portion are spirally connected.

6. The atomization device according to claim 4, wherein one of the first connecting portion and the second connecting portion is provided with a spiral groove extending along the central axis, and another of the first connecting portion and the second connecting portion is provided with a guide post that matches the spiral groove, and the guide post is inserted into the spiral groove; and
wherein when the connecting member rotates along the central axis, a position of the guide post within the spiral groove is changed to allow the blocking member to move between the blocking position and the conducting position.

7. The atomization device according to claim 6, wherein the first connecting portion is constructed to form a connecting hole having an opening toward the second connecting portion, a hole wall of the connecting hole is provided two guide posts disposed opposite to each other, the two guide posts are respectively extended radially along the central axis, and an outer wall of the second connecting portion is provided with two spiral grooves, each of two spiral grooves is arranged corresponding to each of the two guide posts; and
wherein an outer wall of the first connecting portion is provided with at least one guide portion, the at least one guide portion is extended along the central axis and limited to the first bracket.

8. The atomization device according to claim 7, wherein the housing assembly further comprises a second bracket disposed within the shell, the second bracket is located on a side of the first bracket away from the first sealing member, and a limiting hole is formed on a side of the second bracket adjacent to the connecting member; and
the connecting member further comprises a fourth connecting portion and a limiting stop, the fourth connecting portion is connected between the second connecting portion and the third connecting portion along the central axis and extends through the limiting hole; the limiting stop is l ocated on an outer wall at a junction of the fourth connecting portion and the second connecting portion and abuts against a side of the limiting hole adjacent to the liquid guide hole.

9. The atomization device according to claim 4, wherein the third connecting portion is meshed with the drive portion.

10. The atomization device according to claim 9, wherein the third connecting portion is in a gear shape, and the drive portion is in a rack shape.

11. The atomization device according to claim 3, wherein the atomization assembly and the housing assembly are collectively constructed to form an airflow channel;
the adjustment member further comprises a connecting plate portion, the drive portion and the adjustment member are respectively connected to the connecting plate portion, and the connecting plate portion is provided with an air inlet hole;
when the adjustment member is located at the first position, the connecting plate portion blocks an air inlet end of the airflow channel, and the blocking member is located at the blocking position and configured to block the liquid guide hole; and
when the adjustment member is located at the second position, the air inlet hole is configured to communicate the adjustment hole with the air inlet end of the airflow channel, and the blocking member is located at the conducting position and configured to open the liquid guide hole.

12. The atomization device according to claim 11, wherein the liquid storage chamber contains a liquid storage cotton, and when the blocking member is located at the conducting position, the blocking member passes through the liquid guide hole and extends into the liquid storage chamber to press against the liquid storage cotton.

13. The atomization device according to claim 12, wherein the conducting position comprises a first sub-conducting position and a second sub-conducting position, the second position comprises a first sub-position and a second sub-position, the air inlet hole comprises a first sub-air inlet hole and a second sub-air inlet hole, and a diameter of the second sub-air inlet hole is larger than that of the first sub-air inlet hole;
when the adjustment member is located at the first sub-position, the first sub-air inlet hole communicates the airflow channel with the adjustment hole, and the blocking member moves a first distance relative to the connecting member along the central axis and extends into the liquid storage chamber to be located at the first sub-conducting position;
when the adjustment member is located at the second sub-position, the second sub-air inlet hole communicates the airflow channel with the adjustment hole, and the blocking member moves a second distance relative to the connecting member along the central axis and extends into the liquid storage chamber to be positioned in the second sub-conducting position; and
wherein the second distance is greater than the first distance.

14. The atomization device according to claim 13, wherein the housing assembly further comprises a second bracket, a second sealing member, and a third sealing member; the second sealing member is sealingly connected between the first bracket and the second bracket, and the third sealing member is disposed between the second bracket and the connecting plate portion, and the third sealing member is constructed to form the air inlet end of the airflow channel; and
when the adjustment member is located at the first position, the connecting plate portion blocks the air inlet end.

15. The atomization device according to claim 14, wherein the housing assembly further comprises a base disposed within the shell, the base and the shell are collectively constructed to form a mounting chamber; the adjustment member is disposed within the mounting chamber, and the base is connected to the first bracket to limit the second sealing member, the second bracket, and the third sealing member between the first bracket and the adjustment member;
a circuit board is disposed between the base and the second bracket, and a control switch is disposed on a side of the circuit board facing the adjustment member; and
the adjustment member further comprises a trigger portion disposed on the connecting plate portion and sleeved onto the control switch;
wherein when the adjustment member is located at the first position, the connecting plate portion blocks the air inlet end, the sealing member blocks the liquid guide hole, and the trigger unit turns off the control switch;
when the adjustment member is located at the first sub-position, the first sub-air inlet hole communicates the airflow channel with the adjustment hole, the blocking member moves a first distance relative to the connecting member along the central axis and extends into the liquid storage chamber to be located at the first sub-conducting position, and the trigger unit turns on the control switch; and
when the adjustment member is located at the second sub-position, the second sub-air inlet hole communicates the airflow channel with the adjustment hole, the blocking member moves a second distance relative to the connecting member along the central axis and extends into the liquid storage chamber to be located at the second sub-conducting position, and the trigger unit turns on the control switch.

16. The atomization device according to claim 13, wherein the housing assembly further comprises a base disposed within the shell, the base and the shell are collectively constructed to form a mounting chamber, and the adjustment member is disposed within the mounting chamber;
and
a mutually cooperating elastic engagement structure is provided between the adjustment member and the base, the elastic engagement structure is configured to limit the adjustment member to be located at one of the first position, the first sub-position, and the second sub-position.

17. The atomization device according to claim 16, wherein the adjustment member comprises a first elastic engagement arm and a second elastic engagement arm, the first elastic engagement arm and the second elastic engagement arm are disposed on opposite sides of the connecting plate portion along a movement direction of the adjustment member, the first elastic engagement arm is provided with a first engagement portion, and the second elastic engagement arm is provided with a second engagement portion;
the base comprises a first engagement groove, a second engagement groove, and a third engagement groove corresponding to the first engagement portion, respectively, and a fourth engagement groove, a fifth engagement groove, and a sixth engagement groove corresponding to the second engagement portion, respectively;
when the adjustment member is located at the first position, the first engagement portion is located in the first engagement groove, and the second engagement portion is located in the fourth engagement groove;
when the adjustment member is located at the first sub-position, the first engagement portion is located in the second engagement groove, and the second engagement portion is located in the fifth engagement groove; and
when the adjustment member is located at the second sub-position, the first engagement portion is located in the third engagement groove, and the second engagement portion is located in the sixth engagement groove.

18. The atomization device according to claim 3, wherein the shell comprises a first shell and a second shell, the first shell and the second shell are connected to form an accommodating chamber, and a nozzle is formed on an end of the first shell away from the second shell; the first bracket is disposed within the accommodating chamber, the atomization assembly is inserted between the first bracket and the first shell and is in communication with the nozzle; the first sealing member is sealingly connected between the first bracket, the atomization assembly, and the first shell; and the first sealing member, the first bracket, the atomization assembly, and the first shell are collectively constructed to form the liquid storage chamber.

19. The atomization device according to claim 18, wherein the atomization assembly comprises an outer tube, an inner tube, a filling cotton, a liquid guide cotton, and a heating element;
the outer tube is sealingly inserted between the first bracket and the nozzle, the inner tube is coaxially disposed within the outer tube, the filling cotton is filled between the outer tube and the inner tube, the liquid guide cotton and the heating element are respectively disposed within the inner tube, and the liquid guide cotton is interposed between the heating element and an inner wall of the inner tube; and
the outer tube is provided with a first liquid-passing hole, and the inner tube is provided with a second liquid-passing hole; the aerosol matrix contained in the buffer chamber is able to enter the liquid guide cotton through the first liquid-passing hole, the filling cotton, and the second liquid-passing hole in sequence, and the aerosol matrix is heated and atomized by the heating element on the liquid guide cotton to form an aerosol.
